(19) United States
(12) Patent Application Publication
(10) Pub. No.: US 2003/0220118 A1
(43) Pub. Date: Nov. 27, 2003

(54) Conserving energy in networks

(76) Inventor: Jasmeet Chhabra, Hillsboro, OR (US)

Correspondence Address: Timothy N. Trop, TROP, PRUNER & HU, P.C., STE 100, 8554 KATY FWY, HOUSTON, TX, 77024-1841, US

(21) Appl. No.: 10/153,935

(22) Filed: May 22, 2002

(51) Int. Cl. H04Q 7/20

(52) U.S. Cl. 455/459; 455/458

(57) ABSTRACT

In accordance with one embodiment of the present invention, a wireless network may receive intent messages during predetermined intent slots. All of the network nodes may awaken to receive intent messages from other nodes, or only some may if there is no need for some of them to communicate with that node in that specific slot. Those intent messages provide a time, measured from the time of the intent message, when a payload message will be sent. The times for sending the payload messages may be randomly selected with corrections as needed, based on information that a given node has with respect to payload transmission times of other nodes.

### BACKGROUND

This invention relates generally to networks, including wireless networks and particularly to conserving energy in those networks.

In a number of cases, ad hoc wireless networks may include nodes that must be continuously powered on in order to know when a message is coming. This unnecessarily depletes energy and, where the system is battery powered, limits the usefulness of a system.

A number of efforts have been proposed to overcome the energy consumption problem in wireless networks. However, many of these require a globally synchronized time system, at least one node to be on all of the time, or an overly complicated negotiation scheme between the nodes to establish a communication. Thus, in some cases, energy conservation has been achieved by substantially decreasing the efficiency of the overall network.

Thus, there is a need for still better ways to improve the energy conservation of networks.

### BRIEF DESCRIPTION OF THE DRAWINGS

FIG. 1 is a schematic depiction of an wireless network in accordance with one embodiment of the present invention;

FIG. 2 is a state diagram for an wireless network in accordance with one embodiment of the present invention;

FIG. 3 is a flow chart in accordance with one embodiment of the present invention;

FIG. 4 is another flow chart in accordance with one embodiment of the present invention;

FIG. 5 is another flow chart in accordance with one embodiment of the present invention; and

FIG. 6 is still another flow chart in accordance with one embodiment of the present invention.

### DETAILED DESCRIPTION

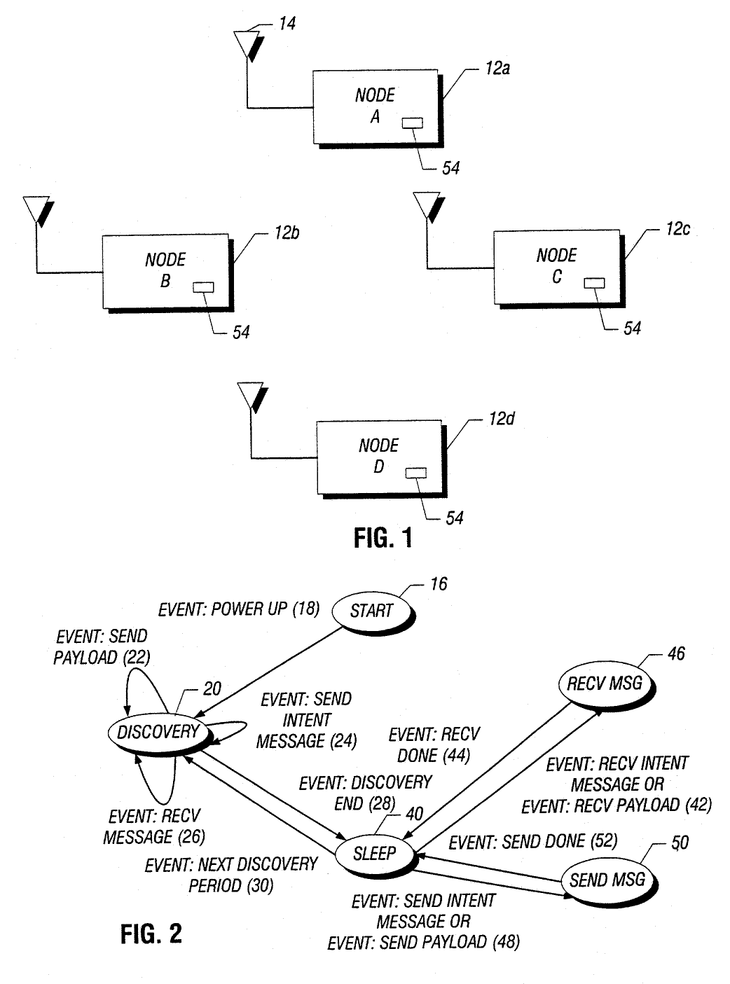

Referring to FIG. 1, a wireless network may include a plurality of nodes 12 each including a receiving device 14. In some embodiments, the nodes 12 may be radio frequency nodes in which case the receiving device 14 is an antenna. In other embodiments, the nodes 12 may be infrared receiving nodes, microwave receiving nodes, or any of a variety of other types of nodes. There is no limit on the number of nodes and multi-hop and single hop networks may be used.

In one embodiment of the present invention, the wireless network composed of the nodes 12 may be expanded or contracted when any node comes into the vicinity or range of the other nodes, or when any node leaves the network's vicinity. Thus, an ad hoc wireless network may be continuously revised, modified, expanded and reduced. The range of the network may be a function of the particular wireless technology that is utilized.

Each of the nodes 12 may be a processor-based device with a storage 54 that stores software to implement an energy conservation scheme. In some embodiments, the storage may be a non-volatile memory such as a flash memory. Thus, each node 12 may be self-sufficient. Thus, a master/slave protocol may be unnecessary; however, in some embodiments, master/slave protocols may be utilized with embodiments of the present invention.

Referring to FIG. 2, a state diagram for a node 12, in accordance with one embodiment of the present invention, begins at start 16. Upon power up, indicated as 18, the node 12 enters the discovery mode 20. In the discovery mode 20, the potential events include sending a payload as indicated at 22, sending an intent message as indicated at 24 and receiving a message as indicated at 26. An intent message is a transmission that occurs during an assigned intent slot. The intent message provides an indication that a payload message will be sent at a defined time. That defined time is measured relative to the time of the transmission of the intent message. A given node may have an intent slot or time when intent messages are transmitted by that node.

The implementation of the intent slot may be subject to considerable variation. Networks may broadcast intent slot times in accordance with one embodiment of the present invention. As still another alternative, each node 12 may be preprogrammed with an intent slot time or time interval. Each intent slot time may be periodic so that, at given intervals of time, all the nodes of a network awaken to receive intent messages. This intent slot time may be predetermined once and then fixed, or may be periodically changed in a pre-determined manner, such that other nodes can calculate the next intent slot time by local computation.

Instead of going into discovery mode periodically, after the first discovery period, a node may choose just to solicit new nodes in a specific time interval. This puts the energy burden of new node discovery mostly on the new nodes. A node that has finished its first discovery period may periodically solicit new neighbors by specifying a fixed time interval when it would be awake to find out about new neighbors. It sends the start of this time interval in its intent slot. Any new neighbor that has come up recently may then choose to inform the node about its intent slot in this time interval. The node then adds the intent slot time of the neighbor in its storage. This allows the nodes already in the network to sleep more thereby saving even more energy. A node may choose not to go into discovery period at all after the first one, or may choose to do so occasionally, but much less frequently.

The discovery mode 20 may be exited in the event that the discovery mode ends as indicated at 28. The discovery mode may end, for example, when a predetermined fixed time interval expires. The node 12 then goes into the sleep mode 40 wherein it is powered down to save energy. For example, in connection with processor-based nodes 12, those processors may enter reduced power consumption states. Often, in reduced power consumption states, the processor's ability to respond immediately to events may be delayed.

From the sleep mode 40, a node 12 may return to the discovery mode 20 in response to the next discovery period as indicated at 30. Alternatively, in the event of a received intent message or payload as indicated at 42, a node 12 may go into the receive message mode 46.

A node 12 may leave the receive message mode 46 when receiving is done as indicated at 44. The node 12 then returns automatically to the sleep mode 40.

Alternatively, a node 12 may leave the sleep mode 40 to send an intent message or to send a payload message as indicated at 48. The node 12 then enters a send message mode 50. From the send message mode 50, the node 12 may return to the sleep mode 40 after it has sent the message as indicated at 52.

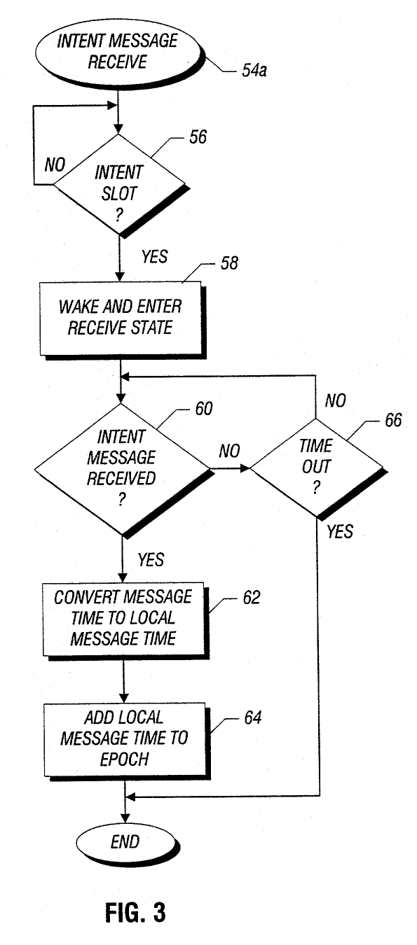

Referring to FIG. 3, the intent message receive software 54a, in one embodiment, may be responsible for receiving intent messages from other nodes 12 as indicated at 42 in FIG. 2. Initially, a check at diamond 56 determines whether an intent slot time has arrived. An intent slot is a predetermined time in which intent messages are exchanged by a node. If the intent slot time has arrived, the node 12 automatically awakens and enters a receive state as indicated in block 58.

In the receive state, a check is made at diamond 60 to determine whether or not an intent message has been received from another node 12. If so, the message time is converted to a local message time within the receiving node 12. In other words, the intent message may indicate a time, measured from the time of the intent message, when a payload message will be sent. Each node that receives the intent message then converts the message time into a local time at the receiving node, as indicated in block 62.

In some cases, the intent messages may be directed to identified nodes. In such cases it is not then necessary for unaddressed nodes to convert the message to local time to arrange to receive the message.

Each addressed node (or all nodes in the case of a broadcast message) adds the local message time to an epoch or a list of message times when messages will be received, as indicated in block 64.

In the event that the intent message is not received, a check at diamond 66 determines whether a time out has occurred. If not, the node continues to wait for intent messages. If the time-out has occurred, indicating the end of the intent slot, the flow ends, and the node goes back to sleep.

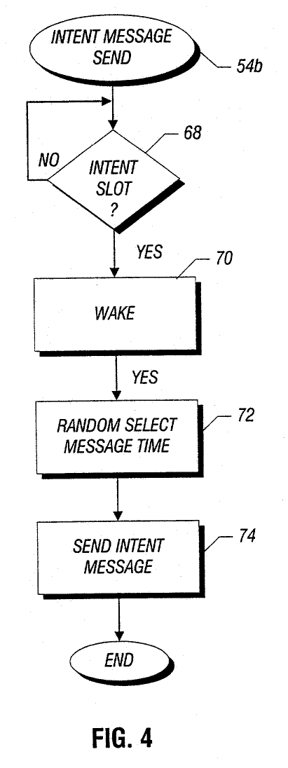

Turning next to FIG. 4, the intent message send software 54b, in one embodiment, implements the sending of an intent message as indicated at 48 in FIG. 2. Initially, a check at diamond 68 determines whether or not the intent slot time has arrived. If so, the node 12 awakes as indicated in block 70. In order to send an intent message, a randomly selected message time is chosen as indicated in block 72. In addition, any randomly selected time may be adjusted for any known message transmission times already stored within the sending node 12. In other words, a random time is selected to send the message, and that random time is sent in the payload of intent message as indicated in block 74. However, if the randomly selected time, in block 72, conflicts with an already assigned message transmission time from another node, then another randomly selected message time may be chosen in some embodiments.

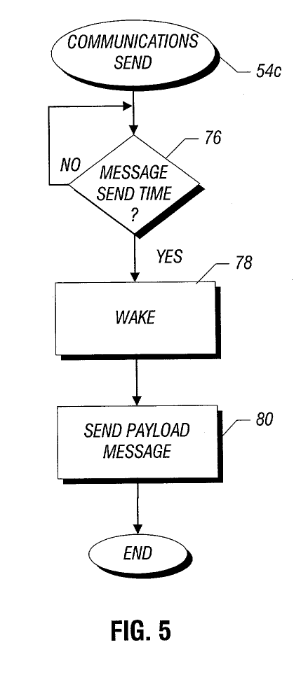

Referring next to FIG. 5, the communications send software 54c, in one embodiment, begins by determining whether a message send time has arrived as indicated in block 76. The communication send software 54c corresponds to the sending of a payload as indicated at 48 in FIG. 4. If it is time to send a payload message, the node 12 that will send the message awakens, as indicated in block 78. The payload message is then sent, as indicated in block 80.

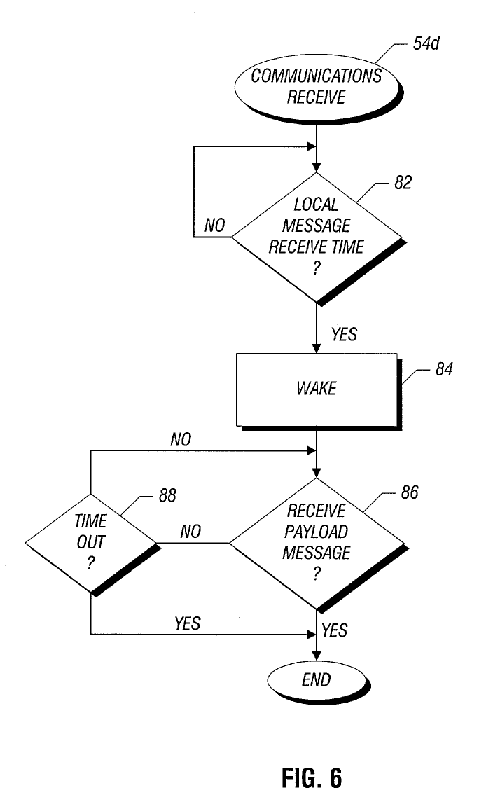

As shown in FIG. 6, a node 12 receiving a message at a time previously conveyed to the node 12 may use the software 54d, in one embodiment, to implement the receiving function indicated at 42 in FIG. 2. When the local message receive time arises, as determined in diamond 82, the node 12 automatically awakens, as indicated in block 84. A check at diamond 86 determines whether the payload message has been received. If so, the flow ends. Otherwise, a check at diamond 88 determines whether a time-out has occurred. If a time-out has occurred, the flow ends nonetheless, returning from the message mode at 46 to the sleep mode 40, as indicated in FIG. 2.

In accordance with some embodiments of the present invention, the need for globally synchronized time keeping function may be avoided. This may significantly decrease the overhead of the system. In addition, relatively little negotiation overhead may be required in some embodiments. The likelihood of contention may be reduced by randomly selecting the transmit time but doing so cognizant of any already preassigned transmit times that have been received from other nodes. Since nodes will primarily remain in the sleep mode, power usage may be relatively low in some embodiments.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
wirelessly receiving an intent message including time information indicating when a payload message will be sent relative to the time when the intent message was sent; and
determining a local time when the payload message should be expected.

2. The method of claim 1 including awakening at a predetermined time to receive an intent message.

3. The method of claim 2 including awakening periodically to receive intent messages.

4. The method of claim 1 including storing the local time when a payload message should be expected.

5. The method of claim 4 including monitoring for the local time and automatically awakening when the local time arrives.

6. An article comprising a medium storing instructions that enable a processor-based system to:
wirelessly receive an intent message including time information indicating when a payload message will be sent relative to the time when the intent message was sent; and
determine a local time when the payload message should be expected.

7. The article of claim 6 further storing instructions that enable the processor-based system to awaken at a predetermined time to receive an intent message.

8. The article of claim 7 further storing instructions that enable the processor-based system to awaken periodically to receive intent messages.

9. The article of claim 6 further storing instructions that enable the processor-based system to store the local time when a payload message should be expected.

10. The article of claim 9 further storing instructions that enable the processor-based system to monitor the local time and automatically awaken when the local time arrives.

11. A system comprising:
a processor;
a receiving device coupled to the processor; and
a storage storing instructions that enable the processor-based system to receive an intent message including time information indicating when a payload message will be sent relative to the time when the intent message was sent and determine a local time when the payload message should be expected.

12. The system of claim 11 wherein said receiving device is a radio frequency antenna.

13. The system of claim 11 wherein said system automatically awakens at predetermined times to receive intent messages.

14. The system of claim 11 wherein said system includes a storage storing a local time when a payload message should be expected.

15. The system of claim 13 including a device to monitor the local time and automatically awake when the local time arrives.

16. A method comprising:
randomly selecting a time to transmit a payload message; and
determining whether any other node in a network has indicated an intent to transmit a payload message at the randomly selected time.

17. The method of claim 16 including randomly selecting another transmit time if another node has already indicated an intent to transmit at the randomly selected time.

18. The method of claim 16 including wirelessly transmitting an intent message including time information indicating when the payload message will be sent relative to the time when the intent message will be sent.

19. The method of claim 18 including automatically wirelessly transmitting said intent message at a predetermined time for the transmission of intent messages.

20. The method of claim 16 including automatically awakening to transmit the payload message at the randomly scheduled time.

21. An article comprising a medium storing instructions that enable a processor-based system to:
randomly select a time to transmit a payload message; and
determine whether any other node in a network has indicated an intent to transmit a payload message at the randomly selected time.

22. The article of claim 21 further storing instructions that enable the processor-based system to randomly select another transmit time if another node has already indicated an intent to transmit at the randomly selected time.

23. The article of claim 21 further storing instructions that enable the processor-based system to wirelessly transmit an intent message including time information indicating when the payload message will be sent relative to the time when the intent message will be sent.

24. The article of claim 23 further storing instructions that enable the processor-based system to automatically wirelessly transmit an intent message at a predetermined time for transmission of intent messages.

25. The article of claim 21 further storing instructions that enable the processor-based system to automatically awaken to transmit the payload message at the randomly selected time.

26. A system comprising:
a processor; and
a storage storing instructions that enable the processor to randomly select a time to transmit a payload message and determine whether any other node in a network has indicated an intent to transmit a payload message at the randomly selected time.

27. The system of claim 26 wherein said system is a wireless communication system.

28. The system of claim 26 wherein said storage stores instructions to enable the processor to randomly select another transmit time if any other node has already indicated an intent to transmit at the randomly selected time.

29. The system of claim 26 further including a storage that receives information from other nodes and stores information about transmit times for payload messages from other nodes.

30. The system of claim 26 wherein said storage stores instructions to enable the processor to wirelessly transmit an intent message including time information indicating when the payload message will be sent relative to the time when the intent message will be sent.

31. A system comprising:
a processor; and
a flash memory storing instructions that enable the processor to randomly select a time to transmit a payload message and determine whether any other node in a network has indicated an intent to transmit a payload message at the randomly selected time.
